(19) United States
(12) Patent Application Publication
(10) Pub. No.: US 2017/0072461 A1
(43) Pub. Date: Mar. 16, 2017

(54) LASER SENSOR FOR MELT CONTROL OF HEARTH FURNACES AND THE LIKE

(71) Applicant: RETECH SYSTEMS LLC, UKIAH, CA (US)

(72) Inventors: JASON TING, UKIAH, CA (US); JOHN MCMENOMEY, UKIAH, CA (US); ORION K. LELAND, UKIAH, CA (US)

(73) Assignee: RETECH SYSTEMS LLC, UKIAH, CA (US)

(21) Appl. No.: 15/254,330

(22) Filed: Sep. 1, 2016

Related U.S. Application Data
(60) Provisional application No. 62/218,699, filed on Sep. 15, 2015.

(51) Int. Cl. B22D 37/00; F27D 19/00; B22D 7/00; F27D 11/08; F27D 11/00; F27D 21/00; F27D 7/06

(52) U.S. Cl. CPC B22D 37/00; F27D 21/0028; F27D 19/00; F27D 7/06; F27D 11/08; F27D 11/00; B22D 7/00; F27D 2019/0006; F27D 2007/066

(57) ABSTRACT

A system and method for sensing the melt level of an ingot and/or molten material within one or more of a melting hearth, a refining hearth, tundish, and/or a casting mold within a furnace system. One or more laser melt height systems is configured and oriented to measure the melt level of one or more furnace system vessels within a closed furnace chamber, and thereby provide control information for regulating an overall melting, refining, casting, and/or atomization process.

### CROSS-REFERENCE TO RELATED APPLICATIONS

This application claims the benefit of U.S. Provisional Application No. 62/218,699, entitled “LASER SENSOR FOR MELT CONTROL OF HEARTH FURNACES AND THE LIKE”, filed on Sep. 15, 2015, the entirety of which is herein incorporated by reference.

### BACKGROUND OF THE INVENTION

In industry, applications such as vacuum metallurgical melting for ingot casting and gas atomization of metallurgical materials are highly dependent on the level, amount, and/or volume of a material within a tundish, crucible, hearth (e.g. a melting hearth, a refining hearth, etc.), mold, and other such vessels that are part of an overall furnace system. The rate of addition or subtraction of material to a furnace system vessel can be controlled or varied, but the level of material, particularly molten material, within a vessel needs to be maintained at a point or within a range of positions during the application process. Existing approaches to monitoring the level of a material within a furnace system vessel, such as visual inspection with a video system, are limited by structural constraints and environmental conditions of the furnace system.

Thus, there remains a need in the industry to for methods and systems to aid in monitoring and determining the level of a material, such as molten material, within a vessel of a furnace system.

### BRIEF SUMMARY OF THE INVENTION

This presently-disclosed invention describes a system and methods for determining the level of a material within a furnace system vessel through the use of a laser sensor, particularly a laser melt height sensor system. A laser melt height sensor system, positioned with the output coupler of the laser oriented toward an open-top furnace system vessel, can emit a laser beam into a sealed chamber, through a general or specialized viewport glass, and interface with a surface. The surfaces of interest within the sealed chamber, such as a vacuum melting chamber with a controlled atmosphere, are molten surfaces and/or ingot surface within furnace system vessels inside the sealed chamber. The laser melt height sensor system can detect the laser signal that reflects off of the surface of interest, and thereby determine the distance from the laser emitter to the surface, and thus calculate a height of the material within a given furnace system vessel.

In some embodiments, the present disclosure is directed to a gas atomization system having: a vacuum chamber having a viewport; a melting crucible; a tundish, configured to receive a molten material from the melting crucible; a gas atomizer; and a laser melt height sensor system, configured to emit a laser beam and receive a laser signal to determine a level of the molten material within the tundish. In some aspects of the system, the tundish can be positioned below the viewport, and the laser melt height sensor system can be positioned above the tundish and viewport, outside of the vacuum chamber. The system can further have a controller electronically coupled to the laser melt height sensor system and the melting crucible, configured to control a rate of at which the melting crucible provides molten material to the tundish based on the laser signal received by the laser melt height sensor system. The system can also have a viewport is formed of a layered glass structure configured to transmit a laser beam into the vacuum chamber having an environment that facilitates a gas atomization process.

In other embodiments, the present disclosure is directed to a vacuum melting system having: a vacuum chamber having one or more viewports; a material feed; a melting hearth, configured to receive a feed material from the material feed and to render the feed material into a molten material, and operatively coupled with a primary heating unit; one or more refining hearths, each configured to receive the molten material from the melting hearth, and each operatively coupled with one or more secondary heating units, respectively; an open-top and open-bottom casting mold, configured to receive the molten material from the one or more refining hearths; and a set of laser melt height sensor systems, each configured to emit a laser beam and receive a laser signal, and arranged to determine a level of molten material in the melting hearth, the one or more refining hearths, and the casting mold. In some aspects of the system, each of the melting hearth, one or more refining hearths, and casting mold can be positioned below a distinct viewport, and a distinct laser melt height sensor system can be positioned above each of the each of the melting heart, one or more refining hearths, and casting mold, outside of the vacuum chamber. In some embodiments, the primary heating unit and the one or more secondary heating units are electron beam guns, and the one or more viewports are formed of a layered glass structure configured to transmit a laser beam into the vacuum chamber having an environment with electron beam guns. In other embodiments, the primary heating unit and the one or more secondary heating units are plasma arc torches, and the one or more viewports are formed of a layered glass structure configured to transmit a laser beam into the vacuum chamber having an environment with plasma arc torches. In further aspects, the system can further include a controller electronically coupled to the set of laser melt height sensor systems material feed, the melting hearth, and the one or more refining hearths, the controller being configured to control a rate at which molten material is provided to the melting hearth, the one or more refining hearths, and the casting mold, based on the laser signal received by the laser melt height sensor system. In further embodiments, the system can also include an ingot position actuator configured to control the position of an ingot formed within the casting mold, where the controller is further electronically coupled to the ingot position actuator and configured to control a rate at which this ingot is withdrawn from the casting mold, based on the laser signal received by the laser melt height sensor system.

In further embodiments, the present disclosure is directed to a method for monitoring the level of a molten material, including the steps of: providing a molten material to a furnace system vessel; emitting a laser beam with a laser melt height sensor system at the molten material; detecting a laser emission reflecting off of the molten material with a laser melt height sensor system; and controlling a rate of the providing of the molten material based on the laser emission detected by the laser melt height sensor system. The method can also include controlling a rate of ingot withdrawal from a casting mold based on the laser emission detected by the laser melt height sensor system. Further, the method can include the step of heating the molten material within the furnace system vessel with a heating unit. In some implementations, the heating unit can be any one of a melting crucible, an electron beam gun, or a plasma arc torch, or a combination thereof. As applied in this method, the laser beam can be emitted in either a pulsed or a continuous mode. Further, the laser beam can be emitted at a wavelength of about 950 nm. In some aspects, the laser emission can be detected at a sampling rate of about 100 Hz.

### BRIEF DESCRIPTION OF THE DRAWINGS

Illustrative aspects of the disclosure are described in detail below with reference to the following drawing figures.

FIG. 1 is a schematic illustration of a vacuum melting system showing a vacuum melting chamber having a laser melt height sensor system, according to aspects of the present disclosure.

FIG. 2 is a programmable logic flowchart for operation of a laser melt height sensor system for a vacuum melting chamber, according to aspects of the present disclosure.

FIG. 3A is a perspective view illustration of an interior portion of a vacuum melting chamber having a progression of hearths and a laser sensor, according to aspects of the present disclosure.

FIG. 3B is a side cross-sectional view illustration of the vacuum melting hearths as shown in FIG. 3A having a laser melt height sensor system, according to aspects of the present disclosure.

FIG. 4 is a flowchart illustrating a method of operation of a vacuum melting system having laser melt height sensor system, according to aspects of the present disclosure.

FIG. 5 is a schematic illustration of vacuum melting system having a laser melt height sensor system, according to aspects of the present disclosure.

FIG. 6 is a schematic illustration of vacuum melting system having an electron beam system and a set of laser melt height sensor systems, according to aspects of the present disclosure.

FIG. 7 is a schematic illustration of vacuum melting system having a plasma arc torch system and a set of laser melt height sensor systems, according to aspects of the present disclosure.

FIG. 8 is a schematic illustration of gas atomization system having a tundish and a laser melt height sensor system, according to aspects of the present disclosure.

FIGS. 9A, 9B, and 9C are schematic representations of the layer structure of viewport windows for use in chambers in concert with a laser melt height sensor system, according to aspects of the present disclosure.

### DETAILED DESCRIPTION OF THE INVENTION

Throughout this description for the purposes of explanation, numerous specific details are set forth in order to provide a thorough understanding of the many embodiments disclosed herein. It will be apparent, however, to one skilled in the art that the many embodiments may be practiced without some of these specific details. In other instances, known structures and devices are shown in diagram or schematic form to avoid obscuring the underlying principles of the described embodiments.

As used herein, the term “furnace system vessel” can refer to any or each of a tundish, a crucible, a hearth, a copper hearth, a water-cooled hearth, a melting hearth, a refining hearth, a mold, a segmented mold, and the like, or a combination thereof. Further, as used herein, the terms “melt level” and “melt height” can refer to the level or height of a molten material within a furnace system vessel, where the furnace system vessel can have a target melt height (or height range) that is optimal for operation. Additionally, as used herein, the tem “metal/alloy” is used to refer to “metal, intermetallic, and/or alloy” and variations thereof in an abbreviated form.

Generally, hearth installations do not have a sensor system that can directly measure a melt level height within hearths. Directly and accurately knowing the level of the melt height in the hearths would significantly enhance the operational efficiency of hearth melting technology. Knowledge of the melt height during furnace processing would enable the hearth melting technology to have better process control and automation to enhance production throughput. Such information could also provide information to a programmable logic controller (PLC) coupled to the overall furnace system to avoid hearth overflow conditions, which has been a key operational safety concern for all cold hearth systems. An automated melt height monitoring sensor that is coupled to the PLC control process would also allow for feedback control of the position of an ingot within the hearth, benefiting the ingot surface finishing and process consistency.

Accordingly, a laser melt height sensor system (“LMHS”) as described in the present disclosure is applicable to many melting furnace systems used in the industry, such as vacuum melting (VM) for ingot casting, cold hearth melting, and tundish melt level control for gas atomization. The LMHS can be particularly useful for applications using electron beam (alternatively referred to as “eBeam”) melting or plasma-based melting (e.g. plasma arc torch systems) to measure the melt height of molten material in a melting hearth, a refining hearth, and/or a withdrawal mold. The LMHS can be applied in process control, where the knowledge of the height of the melt in a crucible, melt tundish, melting hearth, and/or refining hearth can benefit the melt process, improve the surface quality of a cast ingot, and/or result in a higher quality product. It is the inventors' understanding that no attempt to use a laser-based system for melt level measurement in the industry has ever been successful or even pursued, as the inventors are unaware of any art, articles, or even anecdotes describing an application of any laser system similar to the LMHS as described herein.

Further, knowledge and control of the melt height in a furnace system vessel is beneficial to the equipment operational safety. If an equipment operator knows the accurate melt height of, for example, molten titanium within a refining hearth, the operator can control the melting rate of titanium within a melting hearth that is coupled and configured to pour molten titanium into the refining hearth. Control of the melting rate and corresponding pouring rate can prevent the titanium melt from overflowing the side of the refining hearth causing spillage. Such spillage could force the equipment to shut down, could result in a plant stopping operations for a period of time, and could result in bodily injury. Further, the furnace system can have an alarm or other form of alert raised if the melt level within any of the furnace system vessels reaches a dangerous height.

A LMHS as disclosed herein is positioned, designed, and configured to use a laser beam to determine the distance from the LMHS to a molten surface within a melt chamber, thereby calculating a height of the molten material held in a vessel within the melt chamber, being capable of accounting for the heat emission of the molten material, surface characteristics of the molten material, and/or dispersion effects of the melt chamber atmosphere/environment in order to accurately and precisely measure that distance. The LMHS can include two general components, a laser emitter and a laser detector. The LMHS can be located externally to a melting chamber, with the output coupler of the laser emitter oriented toward an open-top furnace system vessel that is visible through a chamber viewport, where the optical path of the laser emitter is arranged to pass through the viewport. The laser detector of the LMHS can also be arranged to receive a reflected laser signal, reflecting off of material within the furnace system vessel, returning through the same chamber viewport. The chamber viewport can be specially designed or constructed to facilitate the transmission of the laser signal for a given application or LMHS. An automated PLC coupled to the LMHS can use the reflected laser signal received by the laser detector and correspondingly adjust the melting process. Such automated and precise control of the melting process in any furnace system vessel can lead to improved consistency in products formed with a related furnace system.

While commonly referred to as “vacuum” melting, the environment and atmosphere within a VM chamber can in fact have some amount of atmosphere, as appropriate for the application or process. Generally, the atmosphere within a VM chamber is controlled, where the chamber can: be held at or effectively at vacuum (void of gases); contain one or more inert gases, held at a controlled pressure; contain a mixture of inert and reactive gases, held at a controlled pressure; or be otherwise controlled as a closed environment compared to the ambient environment outside the VM chamber. The selection of internal gas and pressure conditions for the VM chamber can be based on processes, such as gas atomization, electron beam heating, or plasma-based heating, performed within the VM chamber. The internal gas and pressure conditions for the VM chamber can also be selected to minimize any diffraction or dispersion of laser beams passing through the interior of the VM chamber.

In applications for industrial gas atomization, the gas atomization rate of a molten metal/alloy, generally referred to as the “melt”, is dependent upon the melt level height in a tundish. The melt is poured from a melt crucible into the receiving tundish. The melt is drained from the bottom of the tundish via a ceramic nozzle to an atomization die. The melt flow rate is related to the melt level (alternatively referred to as the head-height or the top of the melt) in the tundish, such that a precise control of the melt level height in the tundish improves the consistency of the gas-atomized metal powder size. In other words, maintaining a steady inflow of melt to balance for the outflow of melt that is rendered into powder allows for consistent volumes of melt to be atomized, and thus consistent metal powder grain size. Maintaining that balance between inflow and outflow can be accomplished by keeping the melt level within the tundish at a desired height.

The existing commercial gas atomization process requires the manual pouring control of the atomization operator. The operator visually evaluates the melt level in the tundish and decides when and how to replenish the tundish. Depending on operators, the replenishing process could be with a continuous stream or in dosed volume increment. As a result, the gas atomization process becomes highly dependent upon the operators and can have wide consistency variations in powdered particle sizes. Because the melt capacity of the melt crucible can be greater than three thousand pounds (3,000 lbs.), the atomization process can take over one hour, during which the whole process is manually controlled. Automating the rate of melt inflow and outflow from the tundish can provide for greater manufacturing consistency.

Applications for ingot casting include electron beam and plasma arc torch melting technologies used to melt and to consolidate reactive refractory metals, intermetallics, and alloys. The metals/alloys can be held within cooled hearths during processing, where the hearths are typically copper, water-cooled hearths. The metals/alloys melted by such processes include, but are not limited to, titanium (Ti) sponge, Ti sponge-compacts, Ti scraps, Ti bars stocks into titanium and titanium alloy ingots, aluminum feed material, nickel-based superalloys, and the like. In particular, nickel-based superalloys can be used with clean melting practices for the formation of ingots to be used for critical aerospace applications. Other metals, transition metals, intermetallics, metal oxides, metal nitrides, and the like can also be processed in this manner, including, for example, materials or ores containing silicon.

In titanium hearth melting systems incorporating electron beam and plasma beam units, as known in the industry, the molten titanium levels in the copper hearths are controlled by furnace operators located in a remote control room who visually observe the melting level in each of the hearths on monitors. In many embodiments of electron beam systems, there are three copper hearths: the melting hearth, the refining hearth, and the withdrawal mold. In many embodiments of plasma beam systems, there are four hearths: the melting hearth, two refining hearths, and a withdrawal mold hearth. Thus, the configuration of such electron beam and plasma beam systems means that furnace operators need to be highly skilled and experienced to be able to continuously monitor multiple screens to visually track the titanium melt levels in each of the melting hearth, refining hearth(s), and withdrawal mold. The operator has to further mentally track the trends in melt level heights in the multiple vessels to effectively control the titanium ingot melting process to balance the ingot casting process. Because a titanium ingot can weigh over twenty to thirty metric tons (20 to 30 mt), the manual ingot withdraw process can last for more than 6 to 9 hours. Ingots formed of other metals/alloys can also have comparable weights and process formation times. Because the withdrawal process of a ingot in the hearth furnaces is semi-manually determined, the surface quality of the withdrawn ingot has the potential to be inconsistent along the length of the ingot. Further, there is the potential for poor quality consistency between cast ingots. Automating the ingot withdraw process control, that can self-adjust the rate of withdrawal in relation to the melt height, can provide for greater manufacturing quality and consistency.

The LMHS system can also be particularly beneficial for the operational safety of ingot casting equipment. From an operational safety perspective, a worst case scenario in a metal melting operation occurs when the metal melting rate of the feed material inadvertently exceeds the ingot withdraw rate. The excessive feed rate can cause an intermediate refining hearth or the withdrawal mold to overflow with molten metal over the hearth and/or mold walls. This is a serious issue that causes health and safety issues, and in addition results in delays in productions, and serious damage to the system. Audio or visual alarms can be linked to a LMHS, and a controller electronically coupled to a LMHS can automatically stop processing within a system to prevent accidental overflow incidents.

For vacuum sealed melt chamber applications such as in vacuum melting, as well as electron beam and plasma beam cold hearth melting systems for melting titanium and oxygen sensitive alloys, one or more LMHS can be mounted externally to the melt chamber. Each of the one or more LMHS can be mounted over one or more respective viewports, such that a laser beam from can enter and exit the melt chamber via a respective melt chamber viewport. A LMHS can be configured to have a laser emitter and a laser detector mounted together adjacently to one another, such only one viewport per LMHS would be necessary to measure the height of material positioned below the LMHS. For the electron beam and plasma beam systems, a plurality of LMHS can be utilized to monitor the melt height within each of the hearths used by those furnace systems. Further, arrangement of the LMHS outside the melt chamber allows for the efficient use of space within the melt chamber, and prevents exposure of the LMHS to high-temperature or other stressful environmental conditions within the melt chamber.

Each LMHS is configured to monitor the melt height within each hearth in real-time, therefore, in some aspects, the LMHS can have a sampling rate of 1 Hz or greater. In further aspects, the LMHS can have a sampling rate of 5 Hz, 10 Hz, 100 Hz, 0.0001 Hz to 1,000,000 Hz, or any increment, gradient, or frequency range therein. In alternative aspects, the LMHS can sample in batches or pulses, selecting a subset or grouping of the measurement samples to calculate a related melt level. In further aspects, the samples from the LMHS can be filtered to control for signals that meet a band-pass requirement or to limit the amount of data used for any given batch of sample measurements. In some aspects, while the LMHS can emit laser pulses at a given rate, the sampling frequency can be set to select, for example, every fifth or every tenth signal received by the LMHS. The sampling rate chosen for any given can be selected to account for a specific construction of a furnace, assorted types of molds used for casting, and/or variable metals/alloys that are used within the furnace.

Based on the melt levels, tracking the melting process within each hearth, the PCL can adjust the melt flow rate into and out from a hearth, accelerating or decelerating the amount of melt provided in order to maximize melt throughputs and ingot cast rate, while concurrently minimizing the risk of hearth overflow due to melt accumulation within the hearths. The LMHS can be configured such that if the melt height in any furnace system vessel exceeds a safety protocol level, an alarm can be triggered to warn an operator of the excessive melt height, and/or a control failsafe can be triggered so that the pouring of molten material is automatically stopped.

Similarly, the process control algorithms of the PCL can be implemented for the withdrawal mold, such that the melt flow rate, known from the one or more LMHS monitoring the hearths, can be controlled in order to achieve a smooth ingot withdrawal rate that can adapt to the rate of the feed material being melted.

In some embodiments, the LMHS can be configured to emit a laser beam with an optical power of from about one milliwatt to five milliwatts (1-5 mW), or at any increment or gradient of power within that range. The LMHS can be emit a beam in order to center or calibrate the LMHS over a furnace system vessel of interest. In application to determine melt height within a given furnace system vessel, the LMHS can emit a laser beam, at a wavelength (λ) at or about 950 nm±1-10 nm. In other aspects, wavelength of the laser beam can be at or about 910 nm±1-10 nm, 930 nm±1-10 nm, 970 nm±1-10 nm, or 990 nm±1-10 nm. In other aspects, wavelength of the laser beam can be (depending on the laser type) from 150 nm to 10600 nm, or any increment, gradient, or range therein. Further, the wavelength of the LMHS laser beam can be selected to account for the fact that the environment within a VM chamber is hot. That is to say, the heat and changing heat profiles generated by the molten material and heating units within the VM chamber constitutes signal in the infrared (IR) range that can therefore cause signal noise for, attenuation of, or interference with a laser beam. Thus, a LMHS wavelength can be selected to avoid the potentially interfering wavelengths resulting from heat in the VM chamber, and additionally, the LMHS wavelength can be selected to penetrate any gases, smoke, or effluent generated by the molten materials within the VM chamber. Accordingly, the lasers used for LMHS as disclosed here are not limited to IR-type lasers. The LMHS can emit the laser beam in either a continuous or pulsed mode. Both continuous and pulsed laser configurations are suitable for monitoring melt level height. The laser emitter and laser detector can be housed in a temperature controlled, (e.g. water-cooled) housing to prevent overheating of the system, as the LMHS can experience by the heat emanating from the molten melt pool through the viewport, affecting the laser emitter, laser detector, and overall sensor.

In some embodiments, the LMHS can be positioned approximately from about 0.5 meters to about 2.5 meters above a furnace system vessel, or at any distance at increments or gradients within that range. In other embodiments, the LMHS can be positioned less than 0.5 meters above a furnace system vessel, and in yet further embodiments, the LMHS can be positioned more than 2.5 meters above a furnace system vessel. Generally, the LMHS can be oriented such that the laser emitted and laser detector of the LMHS are normal to the plane of the surface measured by the LMHS, where that surface can be molted, solid, or a combination thereof.

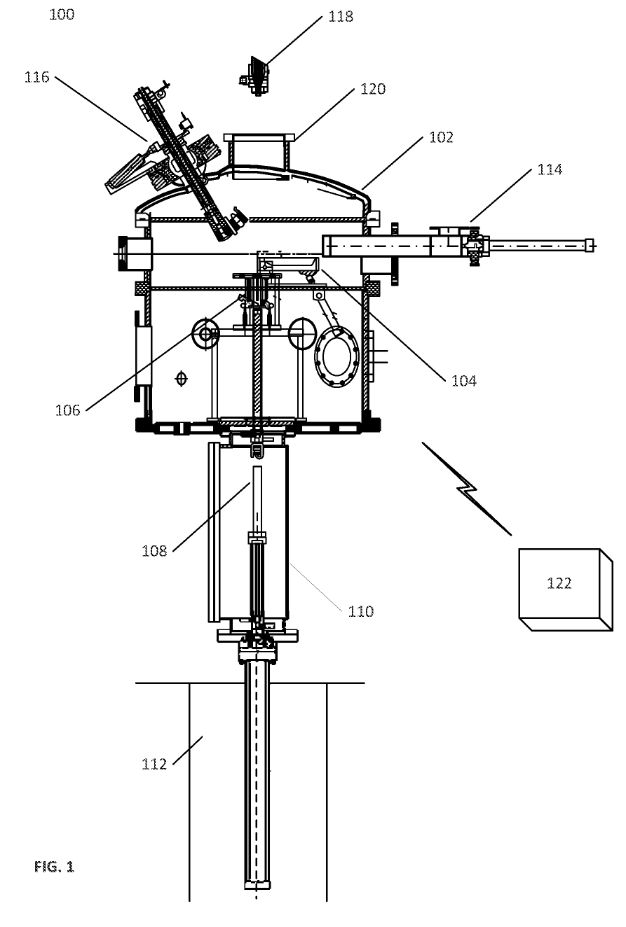

FIG. 1 is a schematic illustration of a vacuum melting system 100 showing a vacuum melting chamber 102 having a LMHS 118. Within the vacuum melting chamber 102 are a material feed 104 and a furnace system vessel 106. The material feed 104 can be positioned and configured to receive raw material (e.g. metals, alloys, etc.) from outside of the vacuum melting chamber 102. As illustrated, a material feed actuator 114 is constructed as part of the vacuum melting system 100, passing through the walls of the vacuum melting chamber 102 and positioned to deliver raw material to the material feed 104. The furnace system vessel 106 can be any one of a variety of vessels for receiving molten material, including but not limited to a tundish, a crucible, a hearth, a copper hearth, a water-cooled hearth, a melting hearth, a refining hearth, a mold, a segmented mold or the like.

An ingot 108 can be formed within the furnace system vessel 106. Particularly, raw and/or molten material provided to the furnace system vessel 106 can be heated and/or irradiated by a directed heating device 116 that is directed at the top of the ingot 108 within the furnace system vessel 106. As the ingot 108 is formed, an ingot position actuator 112 can draw the ingot 108 out of the furnace system vessel 106 and the vacuum melting chamber 102, generally downward, into a withdrawal chamber 110. From the withdrawal chamber 110, a cast ingot 108 can be removed for further application and/or post-processing.

In the illustrated vacuum melting system 100, a LMHS 118 is positioned above the vacuum melting chamber 102, particularly above a viewport 120 in the ceiling of the vacuum melting chamber 102 that is oriented to be above the furnace system vessel 106. The LMHS 118 can further be positioned above the region, often the center, of the furnace system vessel 106 in which the ingot 108 and molten material forming the ingot 108 is located. The LMHS 118 can emit a laser beam through the viewport 120 into the vacuum melting chamber 102 and onto the top surface of the ingot 108 within the furnace system vessel 106. The reflected laser signal off of the top surface of the ingot 108 can in part transmit back through the viewport 120 and be detected by the LMHS 118. The laser beam emitted by the LMHS 118 and the corresponding reflected laser signal detected by the LMHS 118 can be used to determine the distance from the LMHS 118 to the ingot 108, and thereby calculate a height of the ingot 108 in terms of the position of the ingot 108 within the furnace system vessel 106—in other words, the melt level of the ingot 108. In some embodiments, the LMHS 118 can be constructed within a water-cooled housing to prevent overheating of the LMHS 118 due to proximity to thermal heat emanating from the molten material through the viewport 120.

A controller 122 (such as a processor having, in part, a non-transitory computer-readable media and/or a user interface) can be electronically coupled to the LMHS 118 and to the overall vacuum melting system 100 to display or otherwise provide an indication of the melt level. The controller can further control the material feed 104, material feed actuator 114, ingot position actuator 112, and other aspects of the vacuum melting system 100 (such as the gases within and internal pressure of the vacuum melting chamber 102) based, in part, on the calculated melt level of the ingot 108.

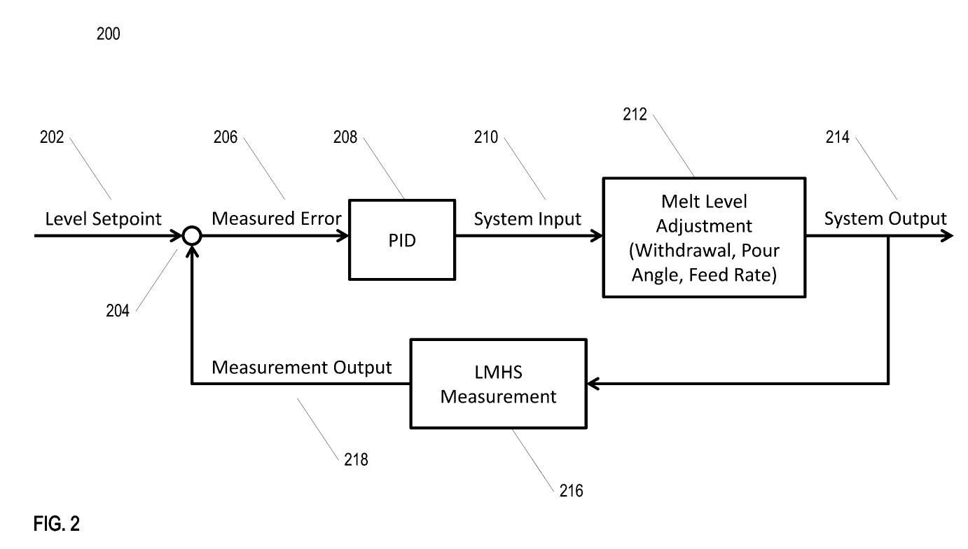

FIG. 2 is a programmable logic flowchart 200 for operation of a laser melt height sensor system for a vacuum melting chamber. The flowchart 200 particularly shows the role of a LMHS in a feedback loop for controlling the melt level within a furnace system vessel. At step 202, a level setpoint is established for the melt level within a given furnace system vessel, which can be a range of heights centered, or otherwise based, on the structural and/or operational characteristics of the furnace system vessel. At junction 204, the level setpoint is compared with a measured level value (the measurement output determined from a LMHS measurement). At step 206, a measured error based on the comparison of the level setpoint and the measured level value is provided to a Proportional-Integral-Derivative (PID) controller. At step 208 the PID controller can determine a correction value needed to return the melt level to the level setpoint. At step 210, a system input is provided from the PID controller corresponding to the correction value. At step 212 the melt level within the furnace system vessel is adjusted. The adjustment of the melt level can be accomplished by increasing, maintaining, or decreasing: the withdrawal of material (e.g. an ingot) out of the furnace system vessel, the pour angle of a material feed providing material to the furnace system vessel, the feed rate of raw material to the material feed, or any combination thereof. At step 214, a system output is achieved (the output being a new or updated melt level). At step 216, a laser melt height sensor system can take a measurement of the melt level within the furnace system vessel. At step 218, the laser melt height sensor system provides the melt level measurement as feedback output for comparison with the level setpoint, to further control and adjust the melt level of the furnace system vessel.

In various aspects and embodiments, multiple LMHS feedback loops can exist for a given vacuum melting chamber, relating to multiple, separate furnace system vessels. The maintenance of melt levels in a plurality of furnace system vessels can be coordinated and balanced to control the overall flow of molten material and ingot casting within a vacuum melting chamber. Factors for consideration and calculation of the feedback signal can include, but are not limited to, values for the level setpoints for the furnace system vessels and individual terms of the PID controller,

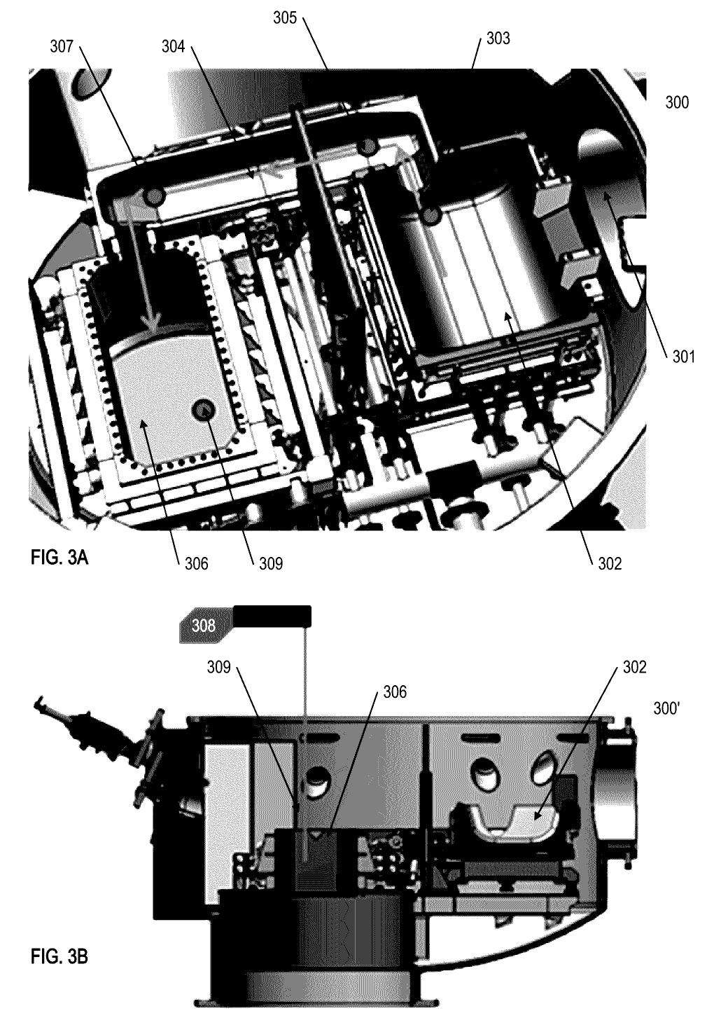

FIG. 3A is a perspective view 300 of an interior portion of a vacuum melting chamber having a progression of hearths and a laser sensor. In the exemplary progression of hearths shown in FIG. 3A, feed material is provided through an inlet 301 to a first hearth 302. In some aspects, the inlet 301 can be a material feed as discussed above, and the inlet 301 can provide either or both of solid metal/alloy feed material. In some embodiments, the first hearth 302 can be characterized or function as a melting hearth. A first measurement point 303 can be located within the area defined by the first hearth 302, where a first LMHS can be positioned such that its laser emitted is centered on the first measurement point 303, and based on the reflected laser signal the first LMHS, thereby measures a melt level in the first hearth 302 at the first measurement point 303.

From the first hearth 302, molten material can pass into a second hearth 304. In some embodiments, the second hearth 304 can be characterized as a refining hearth. The second hearth 304 can have a second measurement point 305 and a third measurement point 307, both located within the area defined by the second hearth 304. A second LMHS can be positioned such that its laser emitted is centered on the second measurement point 305, and similarly, a third LMHS can be positioned such that its laser emitted is centered on the third measurement point 307. The reflected laser signal(s) received by either or both of the second LMHS and third LMHS thereby measures a melt level in the second hearth 304. In some aspects, the melt level in the second hearth 304 can be measured as an average of the laser signals received by the second LMHS and third LMHS, as a weighted combination of the laser signals received by the second LMHS and third LMHS, or as a set of two separate measurements for different regions of the second hearth 304.

From the second hearth 304, molten material can pass into a mold 306, which can be used, for example, for the casting of ingots. The mold 306 can have a fourth measurement point 309, where a fourth LMHS can be positioned such that its laser emitted is centered on the fourth measurement point 309. The reflected laser signal received by the fourth LMHS thereby measures a melt level in the mold 306.

FIG. 3B is a side cross-sectional view 300′ of the vacuum melting hearth as shown in FIG. 3A, further illustrating a LMHS 308 (in this case, the fourth LMHS referred to in FIG. 3A) emitting a laser at the fourth measurement point 309 within the mold 306. The combined set of measurements at all of the measurement points can be used as feedback to guide a controller to regulate the rate and/or amount of feed material is provided to the first hearth 302, as well as the rate and/or amount of molten material passed from the first hearth 302 to the second hearth 304, or from the second hearth 304 to the mold 306.

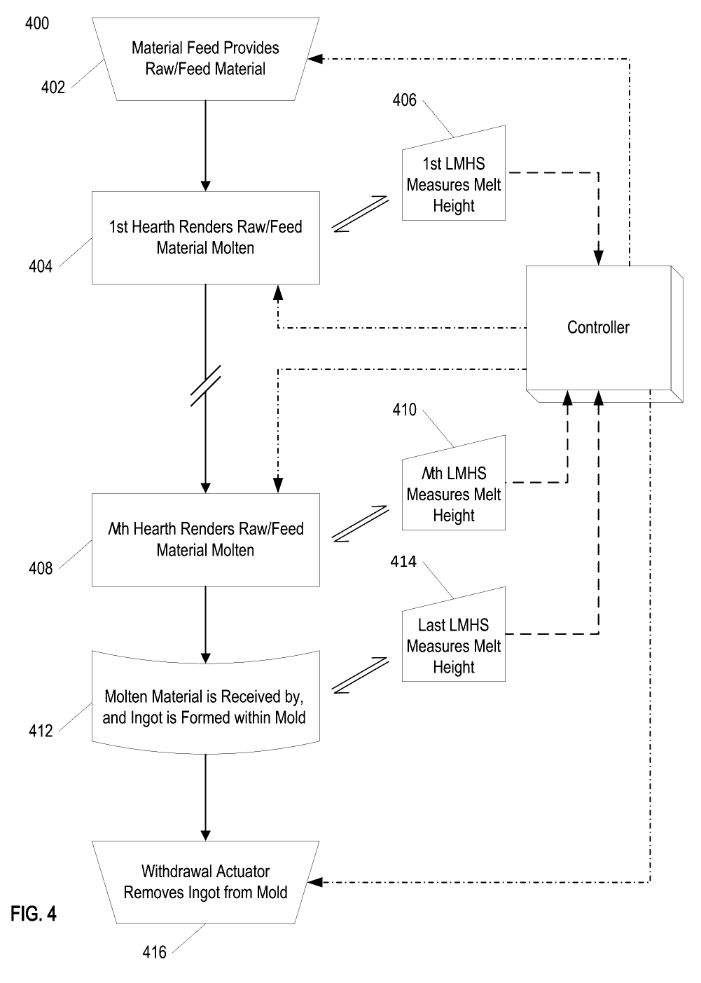

FIG. 4 is a flowchart illustrating a method of operation 400 of a vacuum melting system having laser melt height sensor system. The method of operation 400 can be generally controlled by a controller (having a processor that includes, in part, a non-transitory computer-readable media and/or a user interface), electronically coupled to and controlling apparatus of the vacuum melting system. At step 402, feed material is provided to a material feed, where the feed material can be a metal/alloy and provided in solid form, molten form, or a combination thereof, and where the material feed directs the feed material to a first hearth. At step 404, the first hearth, being coupled to a heating unit, renders the feed material to be fully molten; in other words, any amount of feed material that remains solid will be melted within the first hearth. The first hearth can be operationally coupled to any of a variety of heating units, such as a plasma arc torch, an electron beam gun, inductive heating coils, or the like. In some embodiments, the first hearth can be referred to or used as a melting hearth. At step 406, a first LMHS measures the melt height of the material within the first hearth, and provides the measurement data to the controller. The first hearth then provides the molten material to a subsequent hearth.

At step 408, a subsequent hearth, identified as an Nth hearth, received molten material from upstream in the vacuum melting system. The progression of the molten material from the first hearth to the Nth hearth can be direct between the two hearths, or can include one or more intermediate steps, passing through intermediate hearths (not shown). In some embodiments, the Nth hearth can be referred to or used as a refining hearth, and in further embodiments, any intermediate hearths can be additional refining hearths as part of the overall vacuum melting system. The Nth hearth, being coupled to a heating unit, continues to heat the molten material before providing the molten material to a subsequent furnace system vessel. The Nth hearth can be operationally coupled to any of a variety of heating units, such as a plasma arc torch, an electron beam gun, inductive heating coils, or the like, to heat the molten material within the Nth hearth. At step 410, a Nth LMHS measures the melt height of the material within the Nth hearth, and provides the measurement data to the controller. The Nth hearth then provides the molten material to a subsequent furnace system vessel.

At step 412, molten material is received from the Nth hearth by a mold, and the molten material forms an ingot within the mold. As the ingot is cast within the mold, at step 414, a last LMHS measures the melt height of the material within the mold, and provides the measurement data to the controller. At step 416, a withdrawal actuator removes the cast ingot from the mold, which in some aspects, can include a solid portion of the ingot being drawn out of the mold while additional molten material continues to be added at the top of the mold to form and lengthen the overall ingot. In alternative embodiments of step 412, the molten material can be received by a furnace vessel such as a tundish, where the molten material is then processed, for example, through a gas atomization process.

The data provided to the controller at step 406, step 410, and step 414 allows for feedback-based control of the apparatus of the vacuum melting system. In particular, the controller can adjust each and/or all of: the rate of delivery of feed material by the material feed at step 402; the rate at which the first hearth provides molten material to a subsequent hearth at step 404; the rate at which a subsequent (Nth) hearth provides molten material to a mold, tundish or other furnace system vessel at step 412; and the rate at which the withdrawal actuator withdraws an ingot from a mold at step 416.

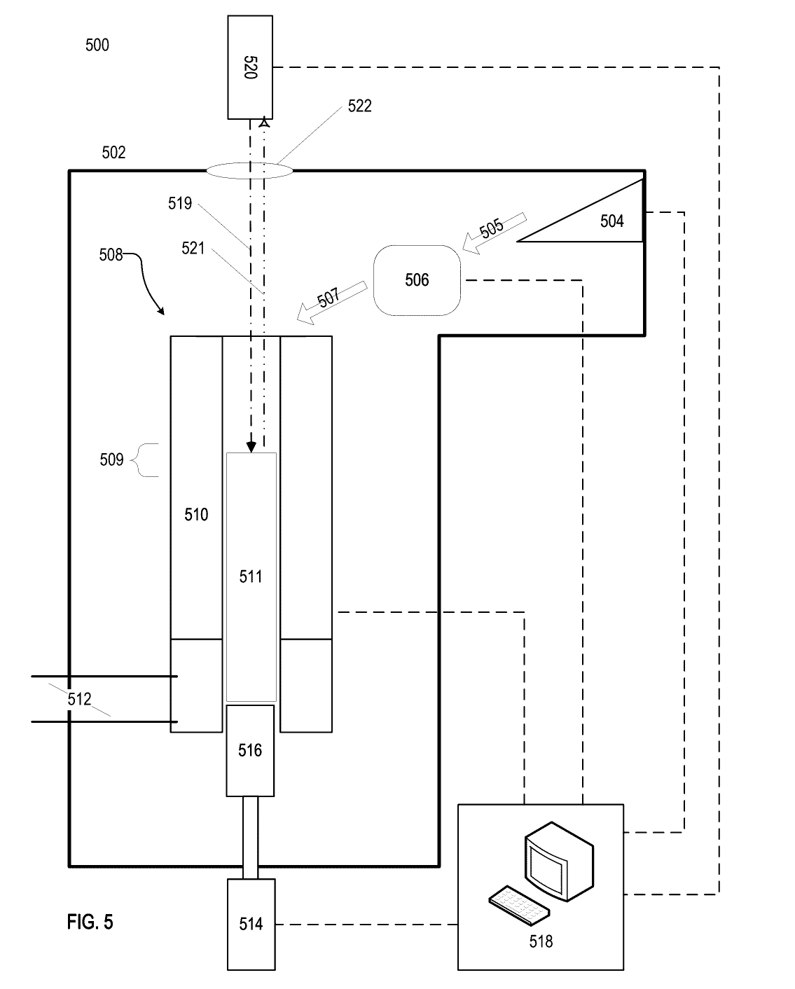

FIG. 5 is a schematic illustration of vacuum melting system having a laser sensor. As shown, a VM furnace system 500 is based in vacuum metallurgical chamber 502. Within the vacuum metallurgical chamber 502 is a material feed 504 a transition vessel 506, and a casting mold 508, where the casting mold 508 is an open-top and open-bottom mold. The material feed 504 can be part of a system where the feed material (metal/alloy) in the material feed 504 is molten before being provided to the casting mold 506. The transition vessel 506 can be a furnace system vessel coupled to a heating unit, in which feed material 505 received from the material feed 504 can be further heated, melted, and/or refined to form a melt 507 of molten metal/alloy. In some aspects, the casting mold 508 can be a water-cooled mold, and/or a segmented mold, vertically oriented within the vacuum metallurgical chamber 502. The molten material in the transition vessel 506, the melt 507, is poured or otherwise provided to the casting mold 508.

In some embodiments, the melt 507 can be transferred to the casting mold 508 by moving the transition vessel 506 to a delivery position and tilt pouring the melt 507 through a pour notch. Once the melt 507 has been transferred, the transition vessel 506 can be returned to a receiving and/or melt position and feed material 505 is directed into the transition vessel 506 from the material feed 504 for subsequent melting into further melt 507.

In some aspects, the metal/alloy in the material feed 504 can be rendered molten by a heating element such as an induction coil positioned proximate to the material feed 504. In various embodiments, the material feed 504 can be positioned inside the vacuum metallurgical chamber 502, outside the vacuum metallurgical chamber 502, or as illustrated in FIG. 5, as a port that is part of the vacuum metallurgical chamber 502 walls.

The mold walls 510 of the casting mold 508 can be cooled via water-cooling conduits 512. An ingot 511 is formed within the casting mold 506 from the melt 507. As the ingot 511 forms, an ingot position actuator 514 can move the ingot 511 within the casting mold 506. In some aspects the ingot position actuator 514 has a withdrawal head 516 configured to receive the ingot 511. As the ingot position actuator 514 draws the ingot 511 out of the casting mold 506, additional melt 507 can be provided to the casting mold 508 in order to maintain the height of the ingot 511 at or around a target level 509 within the mold walls 510.

A controller 518 can be electronically coupled to actuating components of the VM furnace system 500, including the ingot position actuator 514, the transition vessel 506, and the material feed 504, as well as sensors, such as thermal sensors or video cameras coupled to the mold walls 508. The controller can further be electronically coupled to a LMHS 520 positioned above the casting mold 508, outside of the vacuum metallurgical chamber 502. The LMHS 520 can have a laser emitter and a laser detector as part of the laser overall system. The LMHS 520 can be arranged to emit a laser beam along an emission optical path 519 down into the vacuum metallurgical chamber 502, through a viewport 522 in a wall of the vacuum metallurgical chamber 502. The laser beam can interface and reflect off of the ingot 511 as well as any melt 507 resting on top of the ingot 511, and return back toward the LMHS 520 along a reflection optical path 521, through the same viewport 522.

In some aspects, the LMHS 520 can have a sensitivity capable of determining the melt height to within about ten millimeters (±10 mm). In further aspects, the LMHS 520 can have a sensitivity capable of determining the melt height to within about five millimeters (±5 mm), about three millimeters (±3 mm), about two millimeters (±2 mm), or about one millimeter (±1 mm). The LMHS 520, providing the melt height to the controller 518, allows for the controller 518 to adjust (e.g. increase, decrease, or maintain) each or all of: the rate of feed material 505 provided from the material feed 504 to the transition hearth 506, the rate of melt 507 provided from the transition hearth 506 to the casting mold 508, the rate of ingot 511 withdrawal by the ingot position actuator 514, or any other throughput and process flow function coupled to the controller 518 and overall VM furnace system 500.

The viewport 522 can be made of a specialized layered glass, that can include thin film layers of various metal-oxides, metal-nitrides, intermetallics, and the like. Any given viewport 522 can be constructed of various materials and layers to accommodate the function and operation of a given LMHS and targeted furnace system vessel, where the viewport can have different construction, design, and optical characteristics as appropriate for applications that may include gas atomization, electron beam heating, plasma arc torch heating, or other applications used in the industry for VM furnace systems.

Based on the signal received by the laser detector of the LMHS 520 along the reflection optical path 521, the controller 518 can determine the distance between the LMHS 520 and the top surface of the ingot 511 (accounting for the presence of any melt 507 on the top of the ingot 511 within the casting mold 508), and thereby determine the melt height of the material within the casting mold 508. In operation, the amount of melt 507 poured into the casting mold 508 can be controlled to maintain the top of the ingot 511 and melt 507 at or within a range around the target level 509 in any of a continuous, semi-continuous, batch, or iterative mode of production. In some aspects, the careful and precise control of melt height when forming the ingot 511, and the related rate of melt 507 addition to the ingot 511, can provide for an ingot having an advantageous or desired grain structure, such as a grain structure that is generally or uniformly homogeneous, a structure with grain sizes of less than or equal to one hundred micrometers (≦100 μm), or even a structure with grain sizes of less than or equal to fifty micrometers (≦50 μm).

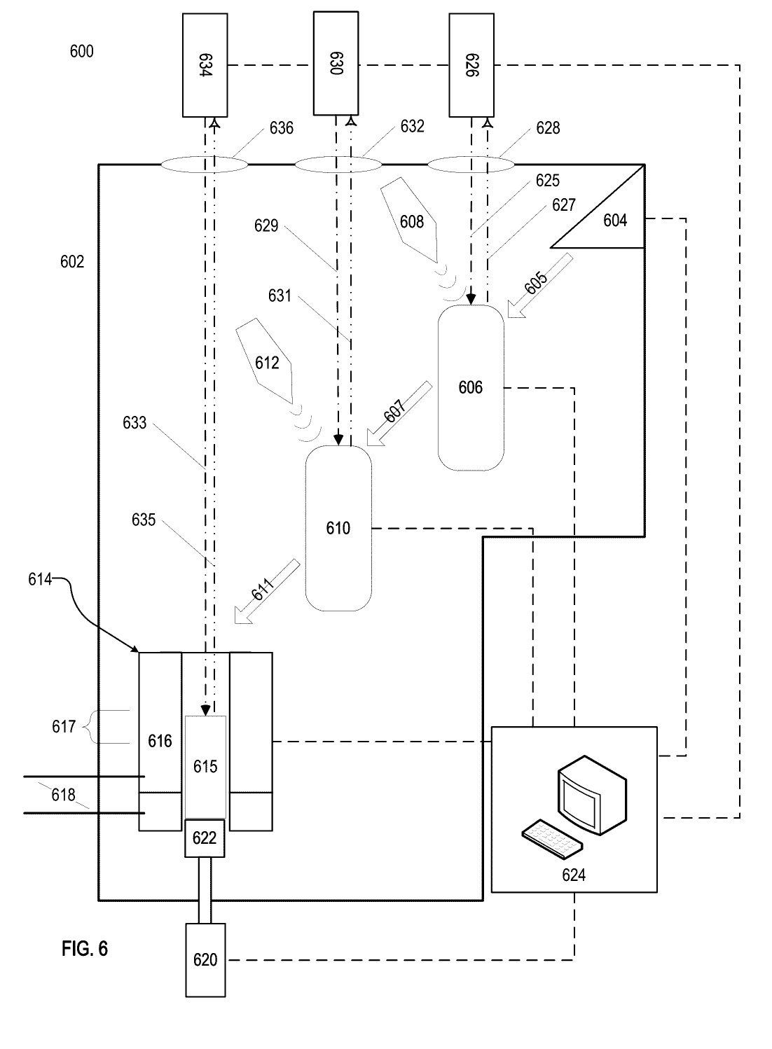

FIG. 6 is a schematic illustration of vacuum melting system having an electron beam system and a set of laser sensor systems. As shown, a VM furnace system 600 is based in vacuum metallurgical chamber 602. Within the vacuum metallurgical chamber 602 is material feed 604, a melting hearth 606, a refining hearth 610, and a casting mold 614, where the casting mold 614 is an open-top and open-bottom mold. In some embodiments, the furnace system 600 can have two or more refining hearths. The material feed 604 can be configured to provide feed material 605 (metal/alloy) to the melting hearth 606 to render the feed material 605 molten. The molten material from the melting hearth 606 can be provided as a first melt 607 to the refining hearth 610, where the molten material is refined in the refining hearth 610 and then provided as a second melt 611 to the casting mold 614. In some aspects, the casting mold 614 can be a water-cooled mold, and/or a segmented mold, vertically oriented within the vacuum metallurgical chamber 602.

The feed material 605 in the melting hearth 606 can be melted with a first electron beam gun 608, targeted and focused at the open-top of the melting hearth 606. The first electron beam gun 608 can thereby render any solid metal/alloy held within the melting hearth 606 molten, into the first melt 607. The molten feed material in the refining hearth 610 can be heated and refined with a second electron beam gun 612, targeted and focused at the open-top of the refining hearth 610. The second electron beam gun 612 can thereby continue to heat the molten material held within the refining hearth 610 molten, which can thereby become the second melt 611 to be conveyed to the casting mold 614. In some aspects, the first electron beam gun 608 can be referred to as a primary directed heating unit and the second electron beam gun 612 can be referred to as a secondary directed heating unit.

The mold walls 616 of the casting mold 614 can be cooled via water-cooling conduits 618. An ingot 615 is formed within the casting mold 614, at least in part, from the second melt 611. As the ingot 615 forms, an ingot position actuator 620 can move the ingot 615 within the casting mold 614. In some aspects the ingot position actuator 620 has a withdrawal head 622 configured to receive the ingot 615. As the ingot position actuator 620 draws the ingot 615 out of the casting mold 614, additional amounts of second melt 611 can be provided to the casting mold 614 in order to maintain the height of the ingot 615 within the casting mold 614 at or around a target level 617 within the mold walls 616.

A controller 624 can be electronically coupled to actuating components of the VM furnace system 600, including the ingot position actuator 620 and the material feed 604, as well as sensors, such as thermal sensors coupled to the mold walls 616. The controller can further be electronically coupled to a set of LMHS positioned above the melting hearth 606, refining hearth 610, and casting mold 614, outside of the vacuum metallurgical chamber 602. Each of the LMHS can have a laser emitter and a laser detector as part of the overall LMHS laser system. Further, each of the LMHS in the furnace system 600 can have a sensitivity capable of determining the melt height of an ingot and/or molten material within a hearth or mold to within about ten millimeters (±10 mm), about five millimeters (±5 mm), about three millimeters (±3 mm), about wo millimeters (±2 mm), or about one millimeter (±1 mm).

As illustrated, a first LMHS 626 can be positioned above the melting hearth 606, and oriented to emit a laser beam along a first emission optical path 625 down into the vacuum metallurgical chamber 602, through a first viewport 628 in a wall of the vacuum metallurgical chamber 602. The laser beam from the first LMHS 626 can interface and reflect off of the molten material held within the melting hearth 606, and return back toward the first LMHS 626 along a first reflection optical path 627, through the first viewport 628. Based on the signal received by the laser detector of the first LMHS 626 along the first reflection optical path 627, the controller 624 can determine the distance between the first LMHS 626 and the molten material held within the melting hearth 606, and thereby determine a melt height within the melting hearth 606.

Similarly, a second LMHS 630 can be positioned above the refining hearth 610, and oriented to emit a laser beam along a second emission optical path 629 down into the vacuum metallurgical chamber 602, through a second viewport 632 in a wall of the vacuum metallurgical chamber 602. The laser beam from the second LMHS 630 can interface and reflect off of the molten material held within the refining hearth 610 (e.g. the first melt 607 poured into the refining hearth 610), and return back toward the second LMHS 630 along a second reflection optical path 631, through the second viewport 632. Based on the signal received by the laser detector of the second LMHS 630 along the second reflection optical path 631, the controller 624 can determine the distance between the second LMHS 630 and the molten material held within the refining hearth 610, and thereby determine a melt height within the refining hearth 610.

A third LMHS 634 can be arranged to emit a laser beam along a third emission optical path 633 down into the vacuum metallurgical chamber 602, through a third viewport 636 in a wall of the vacuum metallurgical chamber 602. The laser beam can interface and reflect off of the ingot 615, as well as any of the second melt 611 resting on top of the ingot 615, within the casting mold 614 and return back toward the third LMHS 634 along a third reflection optical path 635, through the third viewport 638. Based on the signal received by the laser detector of the third LMHS 636 along the third reflection optical path 635, the controller 624 can determine the distance between the third LMHS 634 and the ingot 615 within the casting mold 614, and thereby determine a melt height within the casting mold 614. In some embodiments, each of the first viewport 628, second viewport 632, and third viewport 638 can be a layered glass product specifically designed to facilitate the transmission of laser beams through the vacuum metallurgical chamber 602 having one or more electron beam guns emitting with therein.

The viewports of the vacuum metallurgical chamber 602 can be made of a specialized layered glass, constructed of various materials and layers to accommodate the function and operation of one or more of the LMHS in combination with the electron beam guns within vacuum metallurgical chamber 602, and the related environmental conditions therein.

The first LMHS 626, second LMHS 630, and third LMHS 634, providing the respective melt heights to the controller 624, allows for the controller 624 to adjust (e.g. increase, decrease, or maintain) each or all of: the rate of feed material 605 provided from the material feed 604 to the melting hearth 606, the rate of first melt 607 provided from the melting hearth 606 to the refining hearth 610, the rate of second melt 611 provided from the refining hearth 610 to the casting mold 614, the rate of ingot 615 withdrawal by the ingot position actuator 620, or any other throughput and process flow function coupled to the controller 624 and overall VM furnace system 600.

In an exemplary mode of operation, the amount of second melt 611 poured into the casting mold 614 can be controlled by the controller 624 to maintain the top of the ingot 615 and second melt 611 at or within a range around the target level 617 in any of a continuous, semi-continuous, batch, or iterative mode of production. In some aspects, the careful and precise control of melt height when forming the ingot 615, and the related rate of second melt 611 addition to the ingot 615, can provide for an ingot 615 having an advantageous or desired grain structure, such as a grain structure that is generally or uniformly homogeneous, a structure with grain sizes of less than or equal to one hundred micrometers (≦100 μm), or even a structure with grain sizes of less than or equal to fifty micrometers (≦50 μm).

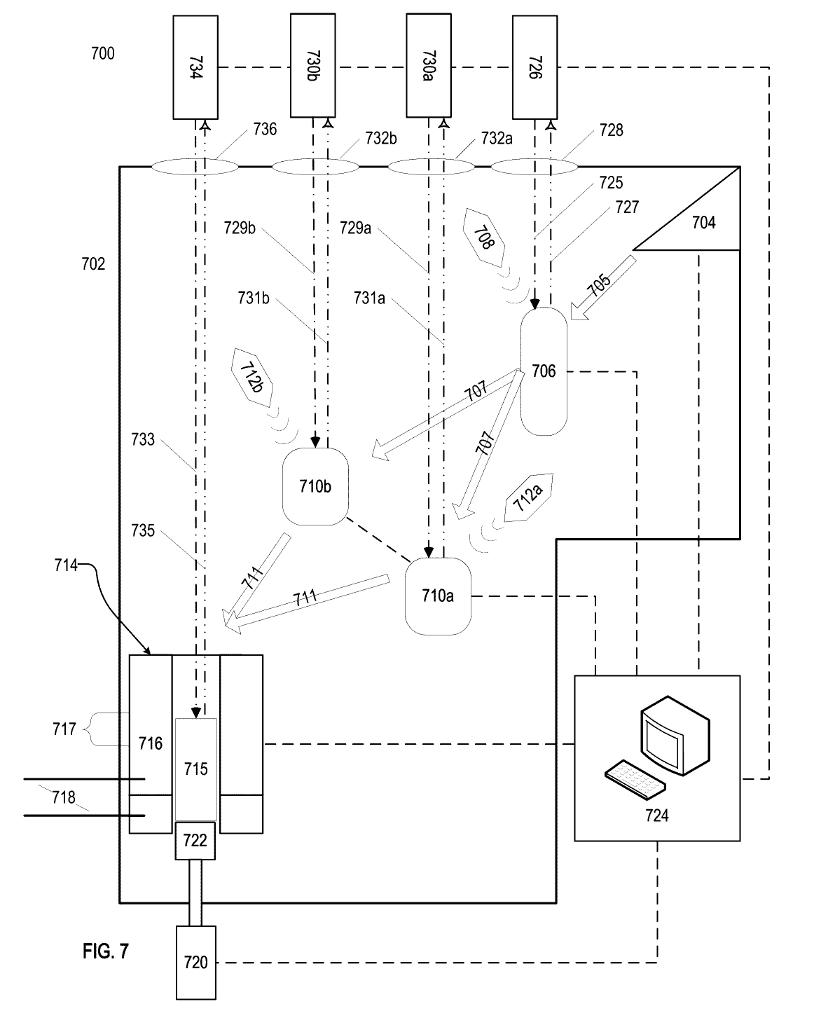

FIG. 7 is a schematic illustration of vacuum melting system having a plasma beam system and a set of laser melt height sensor systems. As shown, a VM furnace system 700 is based in vacuum metallurgical chamber 702. Within the vacuum metallurgical chamber 702 is material feed 704, a melting hearth 706, a first refining hearth 710a, a second refining hearth 710b, and a casting mold 714, where the casting mold 714 is an open-top and open-bottom mold. In some embodiments, the furnace system 700 can have the first refining hearth 710a and the second refining hearth 710b arranged in series, such that the flow of molten material moves sequentially from one refining hearth to the other, with the melting hearth 706 upstream and the casting mold 714 downstream of the refining hearths. In other embodiments, the furnace system 700 can have the first refining hearth 710a and the second refining hearth 710b arranged in parallel, such that the both refining hearths receive molten material from the same melting hearth 706 source, and both feed into the same casting mold 714. The material feed 704 can be configured to provide feed material 705 (metal/alloy) to the melting hearth 706 to render the feed material 705 molten. The molten material from the melting hearth 706 can be provided as a first melt 707 to either or both of the first refining hearth 710a and the second refining hearth 710b, where the molten material is refined in the refining hearths and then provided as a second melt 711 to the casting mold 714. In some aspects, the casting mold 714 can be a water-cooled mold, and/or a segmented mold, vertically oriented within the vacuum metallurgical chamber 702.

The feed material 705 in the melting hearth 706 can be melted with a first plasma arc torch 708, targeted and focused at the open-top of the melting hearth 706. The first plasma arc torch 708 can thereby render any solid metal/alloy held within the melting hearth 706 molten, into the first melt 707. The molten feed material in the first refining hearth 710a can be heated and refined with a second plasma arc torch 712a, targeted and focused at the open-top of the first refining hearth 710a. The molten feed material in the second refining hearth 710b can be heated and refined with a third plasma arc torch 712b, targeted and focused at the open-top of the second refining hearth 710b. In some embodiments, a single plasma arc torch can be used to refine the material in both the first refining hearth 710a and the second refining hearth 710b. The second plasma arc torch 712a and third plasma arc torch 712b can thereby continue to heat the molten material held within the first refining hearth 710a and the second refining hearth 710b, respectively, which can thereby become the second melt 711 to be conveyed to the casting mold 714. In some aspects, the first plasma arc torch 708 can be referred to as a primary directed heating unit, while the second plasma arc torch 712a and/or third plasma arc torch 712b can be referred to as secondary directed heating units.

The mold walls 716 of the casting mold 714 can be cooled via water-cooling conduits 718. An ingot 715 is formed within the casting mold 714, at least in part, from the second melt 711. As the ingot 715 forms, an ingot position actuator 720 can move the ingot 715 within the casting mold 714. In some aspects the ingot position actuator 720 has a withdrawal head 722 configured to receive the ingot 715. As the ingot position actuator 720 draws the ingot 715 out of the casting mold 714, additional amounts of second melt 711 can be provided to the casting mold 714 in order to maintain the height of the ingot 715 within the casting mold 714 at or around a target level 717 within the mold walls 716.

A controller 724 can be electronically coupled to actuating components of the VM furnace system 700, including the ingot position actuator 720 and the material feed 704, as well as sensors, such as thermal sensors coupled to the mold walls 716. The controller can further be electronically coupled to a set of LMHS positioned above the melting hearth 706, first refining hearth 710a, second refining hearth 710b, and casting mold 714, outside of the vacuum metallurgical chamber 702. Each of the LMHS can have a laser emitter and a laser detector as part of the overall LMHS laser system. Further, each of the LMHS in the furnace system 700 can have a sensitivity capable of determining the melt height of an ingot and/or molten material within a hearth or mold to within about ten millimeters (±10 mm), five millimeters (±5 mm), three millimeters (±3 mm), two millimeters (±2 mm), or one millimeter (±1 mm).

As illustrated, a first LMHS 726 can be positioned above the melting hearth 706, and oriented to emit a laser beam along a first emission optical path 725 down into the vacuum metallurgical chamber 702, through a first viewport 728 in a wall of the vacuum metallurgical chamber 702. The laser beam from the first LMHS 726 can interface and reflect off of the molten material held within the melting hearth 706, and return back toward the first LMHS 726 along a first reflection optical path 727, through the first viewport 728. Based on the signal received by the laser detector of the first LMHS 726 along the first reflection optical path 727, the controller 724 can determine the distance between the first LMHS 726 and the molten material held within the melting hearth 706, and thereby determine a melt height within the melting hearth 706.

Similarly, a second LMHS 730a can be positioned above the first refining hearth 710a, and oriented to emit a laser beam along a second emission optical path 729a down into the vacuum metallurgical chamber 702, through a second viewport 732a in a wall of the vacuum metallurgical chamber 702. The laser beam from the second LMHS 730a can interface and reflect off of the molten material held within the first refining hearth 710a (e.g. a portion of the first melt 707 poured into the first refining hearth 710a), and return back toward the second LMHS 730a along a second reflection optical path 731a, through the second viewport 732. Based on the signal received by the laser detector of the second LMHS 730a along the second reflection optical path 731a, the controller 724 can determine the distance between the second LMHS 730a and the molten material held within the first refining hearth 710a, and thereby determine a melt height within the first refining hearth 710a.

Also similarly, a third LMHS 730b can be positioned above the second refining hearth 710b, and oriented to emit a laser beam along a third emission optical path 729b down into the vacuum metallurgical chamber 702, through a third viewport 732b in a wall of the vacuum metallurgical chamber 702. The laser beam from the third LMHS 730b can interface and reflect off of the molten material held within the second refining hearth 710b (e.g. a portion of the first melt 707 poured into the second refining hearth 710b), and return back toward the third LMHS 730b along a third reflection optical path 731b, through the third viewport 732b. Based on the signal received by the laser detector of the third LMHS 730b along the third reflection optical path 731b, the controller 724 can determine the distance between the third LMHS 730b and the molten material held within the second refining hearth 710b, and thereby determine a melt height within the second refining hearth 710b.

A fourth LMHS 734 can be arranged to emit a laser beam along a fourth emission optical path 733 down into the vacuum metallurgical chamber 702, through a fourth viewport 736 in a wall of the vacuum metallurgical chamber 702. The laser beam can interface and reflect off of the ingot 715, as well as any of the second melt 711 resting on top of the ingot 715, within the casting mold 714 and return back toward the fourth LMHS 734 along a fourth reflection optical path 735, through the fourth viewport 736. Based on the signal received by the laser detector of the fourth LMHS 734 along the fourth reflection optical path 735, the controller 724 can determine the distance between the fourth LMHS 734 and the ingot 715 within the casting mold 714, and thereby determine a melt height within the casting mold 714. In some embodiments, each of the first viewport 728, second viewport 732a, third viewport 732b, and fourth viewport 736 can be a layered glass product specifically designed to facilitate the transmission of laser beams through the vacuum metallurgical chamber 702 having one or more plasma arc torches operating therein.

The viewports of the vacuum metallurgical chamber 702 can be made of a specialized layered glass, constructed of various materials and layers to accommodate the function and operation of one or more of the LMHS in combination with the plasma arc torches within vacuum metallurgical chamber 702, and the related environmental conditions therein.

The first LMHS 726, second LMHS 730a, third LMHS 730b, and fourth LMHS 734, providing the respective melt heights to the controller 724, allows for the controller 724 to adjust (e.g. increase, decrease, or maintain) each or all of: the rate of feed material 705 provided from the material feed 704 to the melting hearth 706, the rate of first melt 707 provided from the melting hearth 706 to both the first refining hearth 710a and the second refining hearth 710b, the rate of second melt 711 provided from both the first refining hearth 710a and the second refining hearth 710b to the casting mold 714, the rate of ingot 715 withdrawal by the ingot position actuator 720, or any other throughput and process flow function coupled to the controller 724 and overall VM furnace system 700.

In an exemplary mode of operation, the amount of second melt 711 poured into the casting mold 714 can be controlled by the controller 724 to maintain the top of the ingot 715 and second melt 711 at or within a range around the target level 717 in any of a continuous, semi-continuous, batch, or iterative mode of production. In some aspects, the careful and precise control of melt height when forming the ingot 715, and the related rate of second melt 711 addition to the ingot 715, can provide for an ingot 715 having an advantageous or desired grain structure, such as a grain structure that is generally or uniformly homogeneous, a structure with grain sizes of less than or equal to one hundred micrometers (≦100 μm), or even a structure with grain sizes of less than or equal to fifty micrometers (≦50 μm).

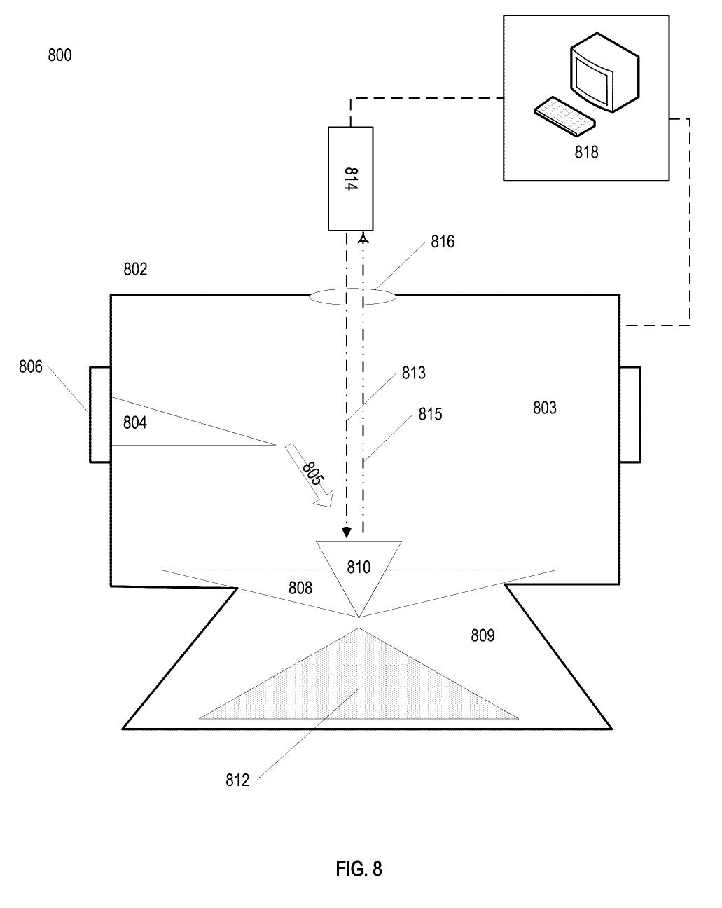

FIG. 8 is a schematic illustration of gas atomization system 800 having a tundish and a laser melt height sensor system. As shown, a VM furnace system 800 is based in vacuum metallurgical chamber 802. Within the vacuum metallurgical chamber 802 is melting crucible 804, a tundish 810, and an internal support structure 808 separating the vacuum metallurgical chamber 802 into an upper region 803 and a lower region 809. A port 806 in the walls of the vacuum metallurgical chamber 802 can provide an access or loading point to provide feed material to the melting crucible 804. Generally, feed material (e.g. any given metal/alloy) provided to the tundish 810 will be in molten form, as a melt 805, either directly or indirectly from the melting crucible 804. The tundish 810, supported by the internal support structure 808, received the melt 805 and can funnel or otherwise direct the melt to an atomization outlet. From the atomization outlet, the melt 805 can enter the lower region 809 and atomized into a metal/alloy powder 812. The metal/alloy powder 812 can be collected and used for relevant applications.

As illustrated, a LMHS 814 can be positioned above the tundish 810, and oriented to emit a laser beam along a emission optical path 813 down into the upper region 803 of the vacuum metallurgical chamber 802, through a viewport 816 in a wall of the vacuum metallurgical chamber 802. The laser beam from the LMHS 814 can interface and reflect off of the molten material held within the tundish 810, and return back toward the LMHS 814 along a reflection optical path 815, through the first viewport 816. A controller 818 can be electronically coupled to actuating components of the VM furnace system 800, including the melting crucible 804. Based on the signal received by the laser detector of the LMHS 814 along the reflection optical path 815, the controller 818 can determine the distance between the LMHS 814 and the molten material held within the tundish 810, and thereby determine a melt height within the tundish 810. Accordingly, the controller 818 can regulate (e.g. increase, decrease, or maintain) the rate at which melt 805 is provided to the tundish 810, and thereby control the rate of metal/alloy powder 812 production. In some aspects, the careful and precise control of melt height when forming the metal/alloy powder 812, and the related rate of melt 805 addition to the tundish 810, can provide for an metal/alloy powder 812 having a consistent desired grain size of less than or equal to one hundred micrometers (≦100 μm), or even consistent grain sizes of less than or equal to fifty micrometers (≦50 μm).

The viewport(s) of the vacuum metallurgical chamber 802 can be made of a specialized layered glass, constructed of various materials and layers to accommodate the function and operation of one or more of the LMHS in combination with the melting crucible 804 within vacuum metallurgical chamber 802, and the related environmental conditions therein.

In an exemplary embodiment, a melt level monitoring system as disclosed herein was used to maintain the melt level in a tundish during melt pouring from the melting crucible in a gas atomization process. The melt poured from a three thousand pound (3,000 lbs.) melting crucible furnace box into a one hundred fifty pound (150 lbs.) tundish. The LMHS was capable of regulating the supply of the melt from the melting crucible to the tundish at a controlled rate to keep the height of the melt level within the tundish steady, such that the melt pour rate was consistently maintained during gas atomization.

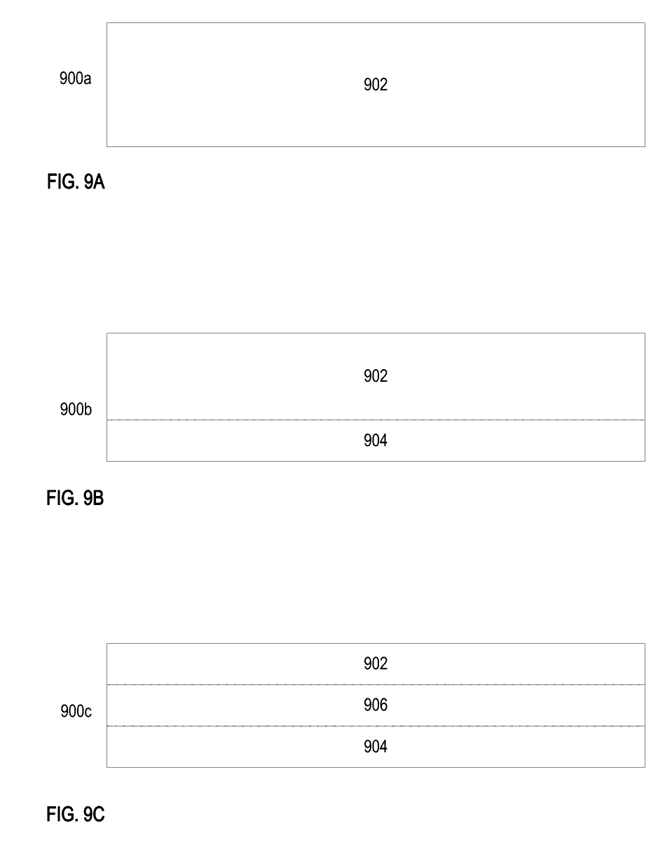

FIGS. 9A, 9B, and 9C are schematic representations of the layer structure of viewport windows for use in chambers in concert with a laser melt height sensor system, where the viewports can be referred to as glasses. The viewports glasses considered herein are all capable of operating with sealed systems under vacuum, under ultra-high vacuum (UHV), and under pressure. FIG. 9A represents the layer structure of a single-layer viewport glass 900a for use with a VM system configured for gas atomization of a molten metal/alloy, and/or a VM system for casting an ingot having a plasma arc torch heating unit. As shown, the single-layer viewport glass 900a includes a single, primary layer 902 made of a glass, which in various embodiments can include pyrex-type glass, sapphire, fused quartz, fused silica, and in further embodiments can be doped with zinc selenide, zinc sulfate, calcium fluoride, germanium, magnesium fluoride, silicon oxide, or the like.

FIG. 9B represents an alternative layer structure of a double-layer viewport glass 900b for use with a VM system configured for gas atomization of a molten metal/alloy, and/or a VM system for casting an ingot having a plasma arc torch heating unit. As shown, the double-layer viewport glass 900b includes the primary layer 902, with an inner, sacrificial layer 904 facing toward the interior of the furnace environment. For the double-layer viewport glass 900b, the primary layer 902 can provide for structural support of the double-layer viewport glass 900b, while the sacrificial layer 904 can tolerate and/or be worn away by the heat, condensate, and other environmental conditions of the VM system chamber. The sacrificial layer 904 helps preserve the double-layer viewport glass 900b, and thereby the seal of the VM system chamber. The sacrificial layer 904 can be made of a the same or a different material as the primary layer 902, and the sacrificial layer 904 can have a thickness less than, equal to, or greater than the thickness of the primary layer 902.

FIG. 9C represents the layer structure of a triple-layer viewport glass 900c for use with a VM system for casting an ingot having an electron beam heating unit. As shown, the viewport glass 900c includes a primary layer 902, a sacrificial layer 904, and a leaded glass layer 906 disposed between the primary layer 902 and the sacrificial layer 904. In electron beam operations, X-rays can be emitted by an electron beam gun within the VM system chamber. Accordingly, in part to protect any operators the triple-layer viewport glass 900c can include the leaded glass layer 906 to minimize, reduce, or eliminate any X-rays from transmitting out through the viewports. For the triple-layer viewport glass 900c, either or both of the primary layer 902 and the leaded glass layer 906 can provide for structural support of the double-layer viewport glass 900b, while the sacrificial layer 904 can tolerate and/or be worn away by the heat, condensate, and other environmental conditions of the VM system chamber. The sacrificial layer 904 helps preserve the triple-layer viewport glass 900c, and thereby the seal of the VM system chamber. The sacrificial layer 904 can be made of a the same or a different material as the primary layer 902, and the sacrificial layer 904 can have a thickness less than, equal to, or greater than the thickness either of the primary layer 902 or the leaded glass layer 906. Similarly, the leaded glass layer 906 can have a thickness less than, equal to, or greater than the thickness the primary layer 902. In some aspects, the leaded glass layer 906 can include materials and/or dopants as discussed for the primary layer 902.

In various embodiments, the triple-layer viewport glass 900c can also be used for applications of a VM system configured for gas atomization of a molten metal/alloy, and/or a VM system for casting an ingot having a plasma arc torch heating unit. In further aspects, any of the single-layer viewport glass 900a, double-layer viewport glass 900b, or triple-layer viewport glass 900c can include thin film coatings (not shown) deposited on the interior and/or exterior sides of the viewport glass to modify, control, or otherwise account for optical transmission through the viewport glass. For any given VM system chamber, the viewport glasses can include any combination of the single-layer viewport glass 900a, double-layer viewport glass 900b, or triple-layer viewport glass 900c as provided herein.

In some aspects, the gas atomization process can be considered an additive process, as the melt is added to the tundish for further atomization. In other aspects, the mold casting processes can be considered subtractive processes, as the melt is added to the casting molds as an ingot is withdrawn out of the open-bottom end of a mold. In all embodiments of the present disclosure, as the melt level within a furnace system vessel changes, either as the top of the ingot position changes within a mold (either by physically moving the ingot down with an appropriate manipulator or by adding molten material to the top of the mold), or by atomizing the molten material within a tundish, the ability to control the amount of molten material in any melting vessel to be at a desired melt height is greatly facilitated by the LMHS.

In alternative embodiments of the present disclosure, the LMHS can be configured such that the laser emitter and the laser detector are configured to be separate from each other. In further alternative embodiments, the laser beam that enters the melt chamber can enter through a first viewport, and the reflected laser beam bouncing off of the molten material can exit the melt chamber through a second view port, different than the first viewport.

It is appreciated that the exemplary data provided herein is not limiting to only the disclosed structural details. Indeed, the system and method disclosed herein is applicable to any width/diameter of ingot, as produced in industry, allowing for the monitoring and related measurement of melt height of an ingot being cast within a mold or of molten material within a hearth. With a relatively larger width/diameter, there may be additional or greater error boundaries, but the principal of melt height measurement remains applicable. The disclosed system and method is further applicable to all metals and/or alloys that can be processed in such furnace systems.

The furnace system, and particularly the controller and (one or more) LMHS, can each include a microprocessor that can further be a component of a processing device that controls operation of the furnace instrumentation and can record measurements of the furnace system. These processing devices can be communicatively coupled to a non-volatile memory device via a bus. The non-volatile memory device may include any type of memory device that retains stored information when powered off. Non-limiting examples of the memory device include electrically erasable programmable read-only memory (“ROM”), flash memory, or any other type of non-volatile memory. In some aspects, at least some of the memory device can include a non-transitory medium or memory device from which the processing device can read instructions. A non-transitory computer-readable medium can include electronic, optical, magnetic, or other storage devices capable of providing the processing device with computer-readable instructions or other program code. Non-limiting examples of a non-transitory computer-readable medium include (but are not limited to) magnetic disk(s), memory chip(s), ROM, random-access memory (“RAM”), an ASIC, a configured processor, optical storage, and/or any other medium from which a computer processor can read instructions. The instructions may include processor-specific instructions generated by a compiler and/or an interpreter from code written in any suitable computer-programming language, including, for example, C, C++, C#, Java, Python, Perl, JavaScript, etc.

The above description is illustrative and is not restrictive, and as it will become apparent to those skilled in the art upon review of the disclosure, that the present invention may be embodied in other specific forms without departing from the essential characteristics thereof. For example, any of the aspects described above may be combined into one or several different configurations, each having a subset of aspects. Further, throughout the foregoing description, for the purposes of explanation, numerous specific details were set forth in order to provide a thorough understanding of the invention. It will be apparent, however, to persons skilled in the art that these embodiments may be practiced without some of these specific details. These other embodiments are intended to be included within the spirit and scope of the present invention. Accordingly, the scope of the invention should, therefore, be determined not solely with reference to the above description, but instead should be determined with reference to the following and pending claims along with their full scope of legal equivalents.

What is claimed is:

1. A gas atomization system comprising:
a vacuum chamber having a viewport;
a melting crucible;
a tundish, configured to receive a molten material from the melting crucible;
a gas atomizer; and
a laser melt height sensor system, configured to emit a laser beam and receive a laser signal to determine a level of the molten material within the tundish.

2. The system of claim 1, wherein the tundish is positioned below the viewport, and wherein the laser melt height sensor system is positioned above the tundish and viewport, outside of the vacuum chamber.

3. The system of claim 1, further comprising a controller electronically coupled to the laser melt height sensor system and the melting crucible, configured to control a rate of at which the melting crucible provides molten material to the tundish based on the laser signal received by the laser melt height sensor system.

4. The system of claim 1, wherein the viewport is formed of a layered glass structure configured to transmit a laser beam into the vacuum chamber having an environment that facilitates a gas atomization process.

5. A vacuum melting system comprising:
a vacuum chamber having one or more viewports;
a material feed;
a melting hearth, configured to receive a feed material from the material feed and to render the feed material into a molten material, and operatively coupled with a primary heating unit;
one or more refining hearths, each configured to receive the molten material from the melting hearth, and each operatively coupled with one or more secondary heating units, respectively;
an open-top and open-bottom casting mold, configured to receive the molten material from the one or more refining hearths; and
a set of laser melt height sensor systems, each configured to emit a laser beam and receive a laser signal, and arranged to determine a level of molten material in the melting hearth, the one or more refining hearths, and the casting mold.

6. The system of claim 5, wherein each of the melting heart, one or more refining hearths, and casting mold are positioned below a distinct viewport, and wherein a distinct laser melt height sensor system is positioned above each of the each of the melting hearth, one or more refining hearths, and casting mold, outside of the vacuum chamber

7. The system of claim 5, wherein the primary heating unit and the one or more secondary heating units are electron beam guns.

8. The system of claim 7, wherein the one or more viewports are formed of a layered glass structure configured to transmit a laser beam into the vacuum chamber having an environment with electron beam guns.

9. The system of claim 5, wherein the primary heating unit and the one or more secondary heating units are plasma arc torches.

10. The system of claim 9, wherein the one or more viewports are formed of a layered glass structure configured to transmit a laser beam into the vacuum chamber having an environment with plasma arc torches.

11. The system of claim 5, further comprising:
a controller electronically coupled to the set of laser melt height sensor systems material feed, the melting hearth, and the one or more refining hearths, configured to control a rate at which molten material is provided to the melting hearth, the one or more refining hearths, and the casting mold, based on the laser signal received by the laser melt height sensor system.

12. The system of claim 11, further comprising:
an ingot position actuator configured to control the position of an ingot formed within the casting mold, wherein the controller is further electronically coupled to the ingot position actuator and configured to control a rate at which this ingot is withdrawn from the casting mold, based on the laser signal received by the laser melt height sensor system.

13. A method for monitoring the level of a molten material, comprising:
providing a molten material to a furnace system vessel;
emitting a laser beam with a laser melt height sensor system at the molten material;
detecting a laser emission reflecting off of the molten material with a laser melt height sensor system; and
controlling a rate of the providing of the molten material based on the laser emission detected by the laser melt height sensor system.

14. The method of claim 13, further comprising:
controlling a rate of ingot withdrawal from a casting mold based on the laser emission detected by the laser melt height sensor system.

15. The method of claim 13, further comprising:
heating the molten material within the furnace system vessel with a heating unit.

16. The method of claim 15, wherein the heating unit is one of a melting crucible, an electron beam gun, or a plasma arc torch.

17. The method of claim 13, wherein the laser beam is emitted in either a pulsed or a continuous mode.

18. The method of claim 13, wherein the laser beam is emitted at a wavelength of about 950 nm.

19. The method of claim 13, wherein the laser emission is detected at a sampling rate of about 100 Hz.
